(19) United States
(12) Patent Application Publication
(10) Pub. No.: US 2022/0416634 A1
(43) Pub. Date: Dec. 29, 2022

(54) SEPARATE COIL MOUNTING STRUCTURE OF COAXIAL EXCITER

(71) Applicant: BUJEON CO., LTD., Ansan-si (KR)

(72) Inventors: Kiseok PARK, Suwon-si (KR); Jiwoong HONG, Ansan-si (KR); Yusik HAM, Seoul (KR)

(21) Appl. No.: 17/411,208

(22) Filed: Aug. 25, 2021

(30) Foreign Application Priority Data
Jun. 25, 2021 (KR) 10-2021-0082976

(51) Int. Cl. H02K 33/14

(52) U.S. Cl. CPC H02K 33/14

(57) ABSTRACT

Disclosed herein is the structure of a separate coil mounting-type coaxial exciter. In the structure of a separate coil mounting-type coaxial exciter, a first body equipped with a first coil, which is an inner coil, and a second body equipped with a second coil, which is an outer coil, are independently separated from each other, the second body has a larger diameter than the first body, each of the first and second bodies has a shape in which the rim thereof extends up and down, and the first coil is joined to the bottom surface of the first body, and the second coil is joined to the bottom surface of the second body.

### CROSS-REFERENCE TO RELATED APPLICATION

This application claims the benefit of Korean Patent Application No. 10-2021-0082976 filed on Jun. 25, 2021, which is hereby incorporated by reference herein in its entirety.

### BACKGROUND

### 1. Technical Field

The present invention relates to the separate coil mounting structure of a coaxial exciter that has a structure in which coils are separately accommodated in an exciter in which a plurality of coils are concentrically arranged.

### 2. Description of the Related Art

Recently, display panels configured to display images are used in various electronic devices such as laptops, tablets, monitors, TVs, and mobile devices, and lighting is generated using OLED panels in lighting devices. In these cases, exciters used are used to generate vibrations corresponding to external electrical energy and directly transmit the generated vibration energy to panels so that acoustic signals are generated from the panels.

A multi-coil exciter uses an inner coil C1′ and an outer coil C2′ as a set, and the inner coil C1′ and the outer coil C2′ are arranged coaxially. As shown in FIG. 8, in a typical arrangement structure, a central portion 102′ and bridges 110′ arranged at equal intervals and branched from the central portion 102′ are included, and there is provided a body frame 100′ in which an inner rim 103′ and an outer rim 104′ are formed in circular shapes on the bottom surface thereof. The inner coil C1′ is joined to the inner rim 103′ and the outer coil C2′ is joined to the outer rim 104′, i.e., both the inner and outer coils C1′ and C2′ are joined to the body frame 100′ in an integrated manner.

Reference numeral 200′ denotes an inner magnet, reference numeral 204′ denotes an inner plate, reference numeral 202′ denotes an outer magnet, reference numeral 206′ denotes an outer plate, and reference numeral 208′ denotes a vibration damper. The inner coil C1′ extends between the two magnets 200′ and 202′, and the outer coil C2′ extends to the outer circumference of the top surface of the outer magnet 202′.

However, in the case of this structure, the two coils are joined to the one body frame at the same time, so that the weight of the body frame and the outer coil is applied to the inner coil at the same time, with the result that a disadvantage arises in that it is difficult to secure high-frequency band characteristics.

Therefore, there is a need for the structure of an exciter in which two coils are mounted on separate bodies, respectively. As an example in which coils and bodies are separated, Korean Patent No. 10-1579171 (entitled “Slim Speaker using Dual Fixed Voice Coil and Magnetic Diaphragm”) discloses a structure including a lower frame 2′, a first fixed-type voice coil 4′ installed on the lower frame 2′, a second fixed-type voice coil 5′ installed on an upper frame 3′, and a magnetic diaphragm 1′, as shown in FIG. 9. Reference numeral 6′ denotes a protective cap, reference numeral 11′ denotes coupling protrusions and depressions, reference numeral 7′ denotes an elastic edge, reference numeral 9′ denotes a coupling plate, and reference numeral 10′ denotes a concentric groove.

However, this structure has a disadvantage in that it is difficult to apply to a coaxial exciter such as that of the present invention because the voice coil 4′ is divided into the upper body and the lower body and the overall structure of the exciter is different.

The present invention has been conceived to overcome the problems in the structures and functions of the coils and frame bodies of the related art described above.

### SUMMARY

The present invention has been conceived to overcome the above-described problems, and an object of the present invention is to provide the separate coil mounting structure of a coaxial exciter that can improve acoustic characteristics in a high-frequency range by reducing the weight applied to coils, allows a flexible wire drawn out from the top of a coil to be efficiently and easily joined to a suspension, and can prevent the introduction of foreign materials

In order to accomplish the above object, the present invention provides the structure of a separate coil mounting-type coaxial exciter, wherein: a first body equipped with a first coil, which is an inner coil, and a second body equipped with a second coil, which is an outer coil, are independently separated from each other; the second body has a larger diameter than the first body; each of the first and second bodies has a shape in which the rim thereof extends up and down; and the first coil is joined to the bottom surface of the first body, and the second coil is joined to the bottom surface of the second body.

A first suspension support may be installed in the center of the first body, a first suspension may be mounted in the upper portion of the space between the first suspension support and the inner circumference of the first body, and the second suspension may be mounted on the outer circumference of the second body.

A terminal portion may be extended to be drawn out from the second suspension through the second body to the inside, and an end of the lead wire of the first coil may be extended to the outside and joined to the terminal portion.

The first and second suspensions may be made of a metallic material or a fabric material.

A breathable member configured to prevent the introduction of foreign materials may be further installed between the outer frame located outside the second body and the second body or second suspension.

One suspension may be mounted in the upper part of a space between the outer circumference of the first body and the inner circumference of the second body

A step may be formed on the edge of the second body, and an end of the lead wire of the first coil may be extended to be drawn out to the outside through the step.

The lead wire of the first coil may be extended along the outer surface of the first coil and connected and joined to a lead pattern on one surface of the suspension.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view showing the structure of a separate coil mounting-type coaxial exciter according to a first embodiment of the present invention when viewed from above;

FIG. 2 is a sectional view of the structure of the separate coil mounting-type coaxial exciter shown in FIG. 1;

FIG. 3 is a view showing the connection structure of the flexible wire of a first coil according to the first embodiment of the present invention;

FIG. 4 is a view of a modification of the first embodiment of the present invention, in which a mesh is installed on a second suspension so as to cover the top of the second suspension; FIG. 5 is a perspective view showing the structure of a separate coil mounting-type coaxial exciter according to a second embodiment of the present invention when viewed from above;

FIG. 6 is a sectional view of the structure of the separate coil mounting-type coaxial exciter shown in FIG. 5;

FIG. 7A is a view showing the connection structure of the flexible wire of a first coil according to a second embodiment of the present invention;

FIG. 7B is a view showing the connection structure of the flexible wire of a first coil according to a second embodiment of the present invention;

FIG. 8 is a view showing the structure of a conventional coaxial exciter; and

FIG. 9 is a view showing an example of a conventional technology in which coils and bodies are separated.

### DETAILED DESCRIPTION

Objects and effects of the present invention, and technical configurations for achieving them will become apparent from the embodiments described later in detail in conjunction with the accompanying drawings. In the following description of the present invention, when it is determined that a detailed description of a well-known function or configuration may unnecessarily make the gist of the present invention obscure, the detailed description will be omitted.

Throughout the specification, when a portion is described as “including” a component, it means that the portion may further include another component, rather than excluding the other component, unless otherwise stated. Meanwhile, in an embodiment of the present invention, each of the components, functional blocks or means may include one or more sub-components.

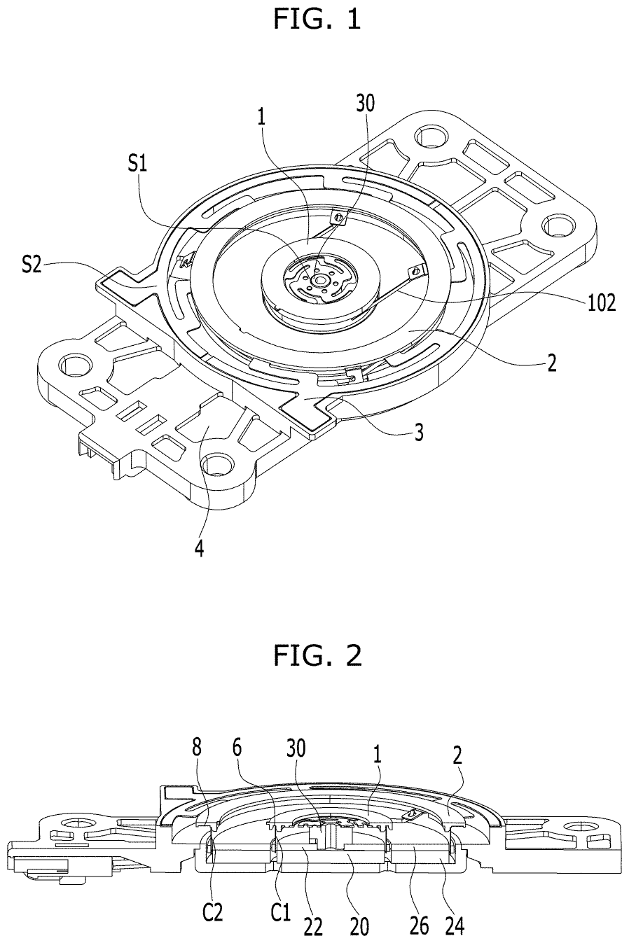

FIG. 1 is a perspective view showing the structure of a coil separately mounted coaxial exciter according to a first embodiment of the present invention when viewed from above.

In the exciter of the present invention, a first body 1 equipped with a first coil C1, which is an inner coil, and a second body 2 equipped with a second coil C2, which is an outer coil, are independently separated from each other (see FIG. 2). The first body 1 is a circular ring-shaped column in which a ring-shaped rim extends up and down. The second body has a larger diameter than the first body 1, and is a circular ring-shaped column in which a ring-shaped rim extends up and down. An outer frame 3 is installed at a predetermined interval outside the second body 2, and side frames 4 each having a substantially rectangular shape extend from both sides of the outer frame 3 in an integrated manner. The outer and inner frames 3 and 4 are classified according to their location for convenience's sake, and in reality, they are fabricated as a “frame” in an integrated form.

A first suspension support part 30 of a hollow column shape is installed in the center of the first body 1. A first suspension S1, which is an inner suspension, is mounted in the upper portion of the space between the outer circumference of the first suspension support part 30 and the inner circumference of the first body 1, and a second suspension S2 is mounted in the upper portion of the space between the outer circumference of the second body 2 and the inner circumference of the outer frame 3. Although the first and second suspensions S1 and S2 are each fabricated in a circular shape in which a plurality of leads or segments are molded in a pattern in an integrated manner, this is an example and various modifications may be possible.

Although the term “suspension” is used in the present specification, it should be interpreted as having a broad meaning including members with different names such as a “damper,” a “membrane,” and a “diaphragm” as long as they can perform the function of harmonizing and damping vibration and be installed in the same position. For example, the suspension of the present invention is made of a metal material such as phosphor bronze, but it may also be made of a fabric material such as the material of a “damper”.

Reference numeral 102 denotes a lead wire 102 drawn out from the upper end of the first coil C1, which will be described later. The lead wire should be broadly understood as being based on a concept including a separate flexible conducting wire mounted to be connected to the wound wire as well as a wire formed by extending the first coil C1 itself to the outside.

FIG. 2 is a sectional view of the structure of the separate coil mounting-type coaxial exciter shown in FIG. 1.

As shown in the drawing, the first body 1 and the second body 2 are physically separated and mounted. The first coil C1 is inserted and attached into an insertion portion 6 formed through the lower surface of the first body 1, and the second coil C2 is inserted and attached into an insertion portion 8 formed through the lower surface of the second body 2. The central axes of the first body 1 and the second body 2 coincide with each other, so that the central axes of the first coil C1 and the second coil C2 form the same coaxial structure.

Reference numeral 20 denotes an inner magnet, reference numeral 22 denotes an inner plate, reference numeral 24 denotes an outer magnet, and reference numeral 26 denotes an outer plate. The first coil C1 extends between the gap between the two magnets 20 and 24, and the second coil C2 extends to the outer circumference of the top surface of the yoke and the outer magnet 24.

In the present invention, the coaxial first and second coils C1 and C2 are completely separated and mounted on the respective bodies 1 and 2, and the suspensions are also connected to the respective coils C1 and C2 and separately install correspondingly. Therefore, sound quality performance may be improved by individually driving the first and second coils C1 and C2 and the corresponding suspensions S1 and S2. In particular, the weight burden of the body and the second coil C2 applied to the first coil C1 may be relieved, so that high-frequency acoustic quality may be secured.

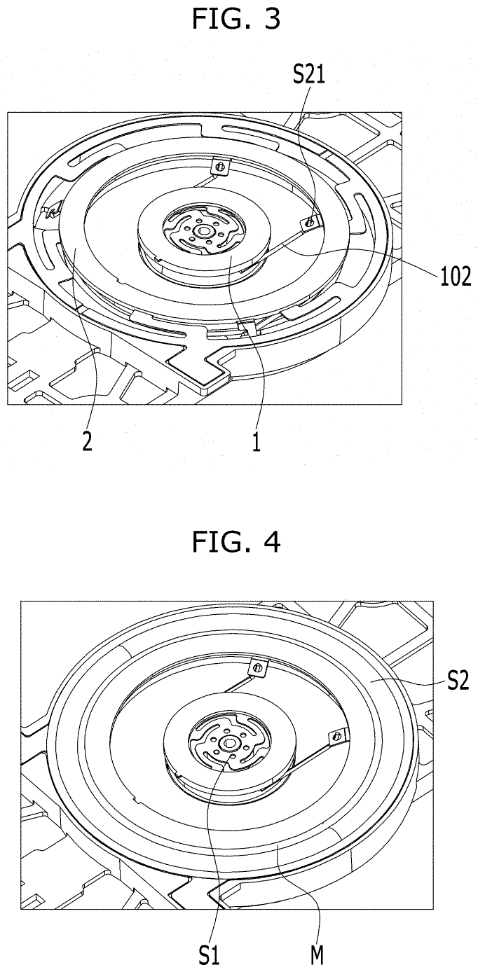

Next, FIG. 3 is basically the same as FIG. 1, and discloses the connection structure of the lead wire 102 of the first coil C1 according to the first embodiment of the present invention. A terminal portion S21 extends to be drawn out from the second suspension S2 through the second body 2, and two ends of the lead wire 102 extend outward are, e.g., soldered to the terminal portion S21. In this method, a conductive structure is formed in the space formed by the first body 1 and the second body 2 without the need to draw the lead wire 102 out of the body to a long length, so that advantages arise in that connection work is simple and unnecessary space is reduced.

Next, FIG. 4 is a modification of the first embodiment of the present invention. A mesh M is installed on the second suspension S2 so as to cover the top of the second suspension S2. This is advantageous in that when the suspension is made of metal, foreign materials such as earwax or dust are prevented from entering from the outside. If the suspension is made of a fabric material, the mesh M may not be necessary because it performs the function of filtering foreign materials to some extent. Although the foreign material prevention structure may be made of a sponge with breathability as well as a mesh, it is not particularly limited to a particular material.

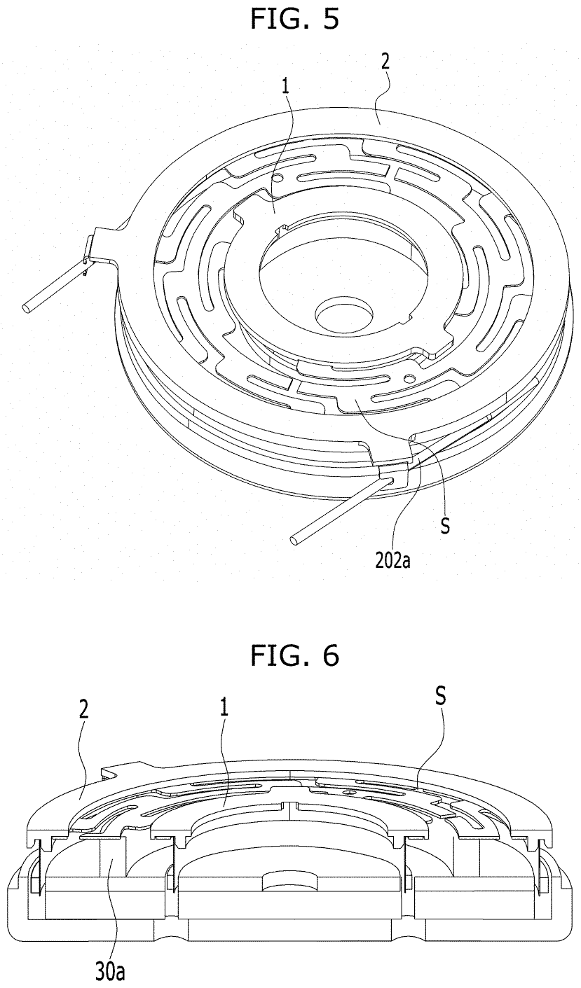

Next, FIG. 5 is a perspective view showing the structure of a separate coil mounting-type coaxial exciter according to a second embodiment of the present invention when viewed from above. FIG. 6 is a sectional view of the structure of a separate coil mounting-type coaxial exciter shown in FIG. 5. The second embodiment has an overall circular structure.

The present embodiment is the same as the first embodiment in that the first body 1 equipped with the first coil C1 and the second body 2 equipped with the second coil C2 are independently separated and the first body 1 and the second body 2 are the same in structure and shape as those of the first embodiment. The diameter of the first body 1 is somewhat larger than that of the first embodiment, but this size does not limit the scope of the present invention. Unlike in the first embodiment, a single suspension S is mounted in the upper portion of the space between the outer circumference of the first body 1 and the inner circumference of the second body 2.

Reference numeral 202a denotes a wire 202a drawn out from the upper end of the second coil C2.

Since the sectional structure of FIG. 6 is basically the same as that of the first embodiment, redundant descriptions will be omitted. In order to support the suspension S, an annular suspension support portion 30a is mounted across the space formed by the first body 1 and the second body 2.

The second embodiment also provides the same effects as the first embodiment.

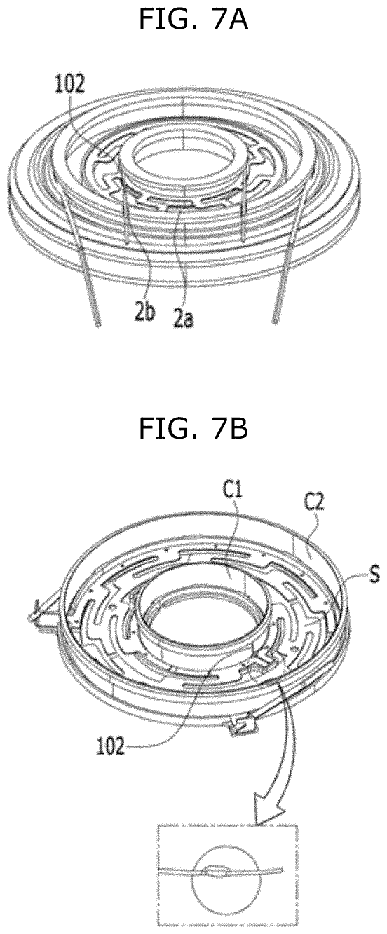

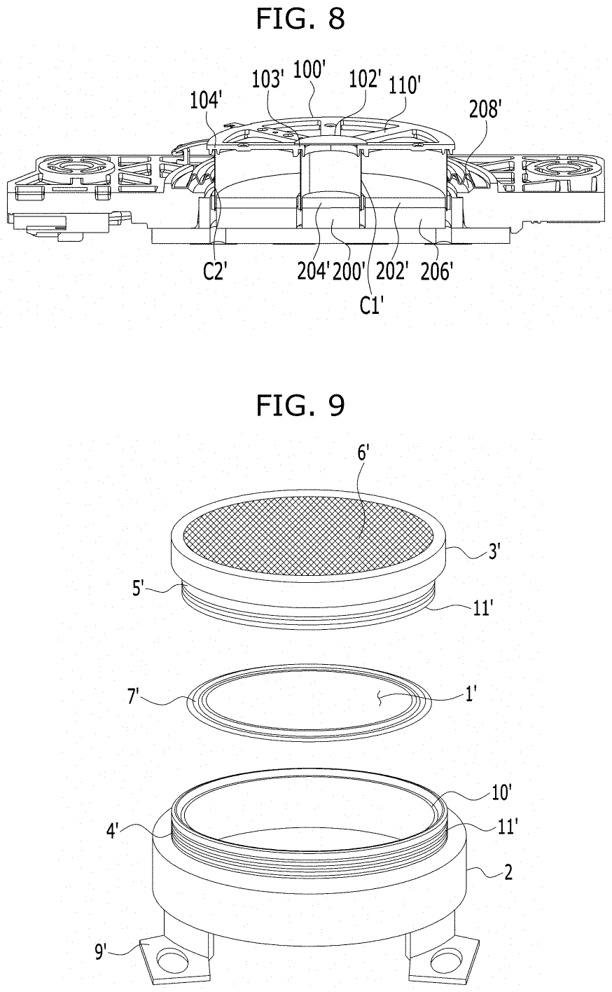

FIG. 7 is a view showing the connection structure of the lead wire 102 of a first coil C1 according to the present invention.

In FIG. 7A, a step 2b is formed on an edge 2a forming the outer circumference of the second body 2, and the two ends of the flexible wire 102 of the first coil C1 extend to be drawn to the outside through the step 2b. The positional variation of the lead wire 102 may be prevented due to the step 2b.

FIG. 7B is a view of the structure of the present invention obtained by reversing the structure of FIG. 7A. The lead wire 102 of the first coil C1 extends downward (upward in terms of the structure of the exciter) along the outer surface of the first coil C1, and is connected to a lead pattern on the bottom surface of the suspension S by a stop welding method. In this case, the space for the connection of the first coil C1 may be reduced, and there is an advantage in that there is no need to form the terminal portion S21 on the suspension S unlike in the embodiment of FIG. 3.

Although the preferred embodiments of the present invention have been described above, various modifications may be possible to the present invention. The structure of the coaxial exciter according to the present invention has versatility that can be applied regardless of the shapes and sizes of other members of the exciter—such as the magnets, the suspensions, the side frames, the yoke, etc. as long as it may be applied to any case where two or more plural coils are used and separate bodies accommodating respective coils are separately fabricated.

Furthermore, although the present invention has been described in conjunction with the coaxial exciter, it may be applied to various sound devices such as a TWS microspeaker, and a woofer and tweeter hybrid speaker.

In the present invention, the coaxial first and second coils are completely separated and mounted on the respective bodies, and the suspensions are also connected to the respective coils and separately mounted correspondingly. Therefore, sound quality performance may be improved by individually driving the first and second coils and the corresponding suspensions. In particular, the weight burden of the body and the second coil applied to the first coil may be relieved, so that an effect may be achieved in that high-frequency acoustic quality may be secured.

Furthermore, according to the present invention, the suspension is mounted in the space between the first body and the second body, and the effect of reducing space and cost may be achieved in addition to the above-described effect.

Moreover, in the coaxial exciter structure of the present invention, the lead wire of the coil is joined inside the space formed by the structure or is drawn out through a path provided by the structure, so that effects are achieved in that wiring work is facilitated and space is reduced.

Other effects of the present invention will become clearer from the foregoing detailed description given with reference to the accompanying drawings.

What is claimed is:

1. A structure of a separate coil mounting-type coaxial exciter, wherein:
a first body equipped with a first coil, which is an inner coil, and a second body equipped with a second coil, which is an outer coil, are independently separated from each other;
the second body has a larger diameter than the first body;
each of the first and second bodies has a shape in which a rim thereof extends up and down; and
the first coil is joined to a bottom surface of the first body, and the second coil is joined to a bottom surface of the second body.

2. The structure of claim 1, wherein a first suspension support is installed in a center of the first body, a first suspension is mounted in an upper portion of a space between the first suspension support and an inner circumference of the first body, and the second suspension is mounted on an outer circumference of the second body.

3. The structure of claim 2, wherein a terminal portion is extended to be drawn out from the second suspension through the second body to an inside, and an end of a lead wire of the first coil is extended to an outside and joined to the terminal portion.

4. The structure of claim 2, wherein the first and second suspensions are made of a metallic material or a fabric material.

5. The structure of claim 4, wherein a breathable member configured to prevent introduction of foreign materials is further installed between the outer frame located outside the second body and the second body or second suspension.

6. The structure of claim 1, wherein one suspension is mounted in an upper part of a space between an outer circumference of the first body and an inner circumference of the second body

7. The structure of claim 6, wherein a step is formed on an edge of the second body, and an end of a lead wire of the first coil is extended to be drawn out to an outside through the step.

8. The structure of claim 6, wherein a lead wire of the first coil is extended along an outer surface of the first coil and connected and joined to a lead pattern on one surface of the suspension.
